(19) United States
(12) Patent Application Publication
(10) Pub. No.: US 2003/0200683 A1
(43) Pub. Date: Oct. 30, 2003

(54) Taxiflag

(76) Inventor: Bob Gailen, Chicago, IL (US)

Correspondence Address: BOB GAILEN, UNIT 6C, 222 E. CHESTNUT, CHICAGO, IL, 60611, US

(21) Appl. No.: 10/133,882

(22) Filed: Apr. 29, 2002

(51) Int. Cl. G09F 21/02

(52) U.S. Cl. 40/586; 116/173

(57) ABSTRACT

A signal flag, flagholder and storage handle that in its open configuration is used for signaling a taxi and to display a sponsors logo or advertisement, and in its closed configuration is stowed in a pocket, purse or briefcase. The device is designed to permit the user or sponsor to interchange made-to-order flags at their discretion.

### CROSS-REFERENCE TO RELATED APPLICATIONS

Known prior art includes U.S. Pat. No. 6,079,350; U.S. Pat. No. 6,155,197; U.S. Pat. No. 4,944,656; U.S. Pat. No. 5,042,419; U.S. Pat. No. D427,102; U.S. Pat. No. 5,168,115

A number of inventions exist that are used to attract the attention of a taxicab that are handheld and retract in some way for storage in a pocket or carried bag. All differ from the present invention in that primarily the present invention is adaptable for use as an advertising medium that can be customized by a user or sponsor of the present invention. Additionally, the present invention differs from previous inventions in that the present invention unfolds and contracts quickly into a handle that conveniently captures and protects the flag.

### STATEMENT REGARDING FEDERALLY SPONSORED RESEARCH OR DEVELOPMENT

Not Applicable.

### REFERENCE TO A MICROFICHE APPENDIX

Not Applicable.

### FIELD OF THE INVENTION

The present invention is in relation to handheld flags as a means of signaling that is housed in a convenient compact storage device. The invention is used for the purpose of hailing a taxicab while also providing a medium for an advertising message.

### BACKGROUND OF THE INVENTION

Travelers and residents of metropolitan areas, especially large and crowded cities rely on hand waving to catch the attention of taxi drivers. This means of hailing a taxi is usually done when the taxi in in sight of the traveler. Often, the taxidriver is unsure of the nature of the waving hand movement as pertaining to the need for the taxi. The taxi driver must be within a direct line of sight to see the outstretched arm of the traveler. The traveler is competing with the movements of other persons near or around that may or may not be attempting to hail a taxi. Other devices for hailing a taxi are whistles or flashing lights. In most instances the whistle and light are only present at hotel or residential building entrances.

It would be beneficial for a traveler to be able to expedite with assurance the ability of a taxi driver to see and understand the need for service. Secondly the present invention is a transportable advertising and promotional device for taxicab companies, the hospitality industry, establishments that cater to travelers, sports teams and sports venues, or anyone wishing to display an advertisement or logo in a unique and novel fashion.

### SUMMARY OF THE INVENTION

The object of the present invention is to provide a handheld devise for hailing/signaling for a taxicab that can be quickly extended for use and easily collapsed for storage in a pocket, purse, or briefcase. An additional object of the present invention is to provide a transportable medium for advertising and promotion. The present invention would be sold or presented as mementos from visits to places, lodging, restaurants, or any other entity seeking to display a logo or other advertising message such as sports teams or schools.

The advantages of the present invention are a compact storage compartment that also serves as the handle for the flagholder. The flagholder is designed so that the flag portion of the invention is replaceable with other flags designed for the present invention. The flags may be easily changed by the advertiser or the user of the present invention.

### BRIEF DESCRIPTION OF THE SEVERAL VIEWS OF THE DRAWING

FIG. 1

Pictures the device in the contracted, closed position. In view is the storage ccmpartment/handle and the flag as it is rolled around the flagholder tucked within the handle.

FIG. 2

Illustrates the device in the extended, open position. The flagholder is seen extending from the handle. The flag remains rolled around the flagholder in this view.

FIG. 3

Illustrates the device in the extended, open position ready for use. The flag is in full view as it is unrolled from the flag holder. The flag has the word TAXI printed on this side.

FIG. 4

Illustrates the device in the extended, open position. The flag is in full view as it is unrolled from the flagholder. The flag has an advertisement printed on this side.

FIG. 5

Illustrates the device in use. The user is holding the handle with the holder extended and flag fully exposed.

### DETAILED DESCRIPTION OF THE INVENTION

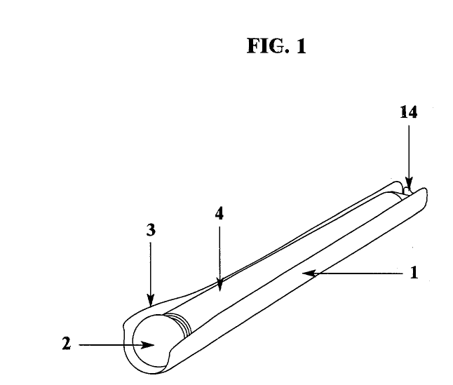

The present invention is shown in the several Views, FIG. 1 thru 5.

As shown in FIG. 1: the handle 1, made from molded plastic having a rough finish to provide a secure grip. The molded plastic ball 2 is shown nesting in the flared end 3 of the handle and held in place by friction. The nylon flag 4 is rolled around the flagholder and nesting within the handle.

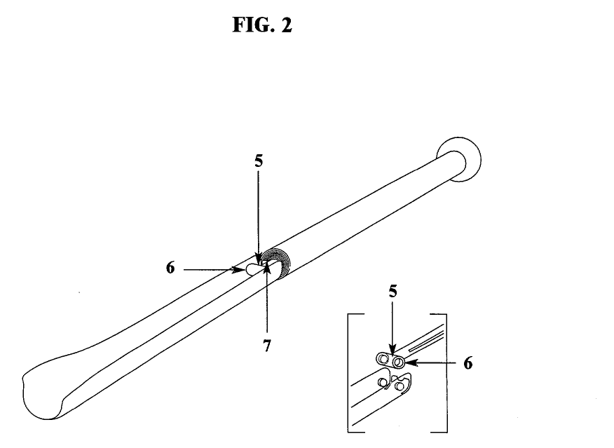

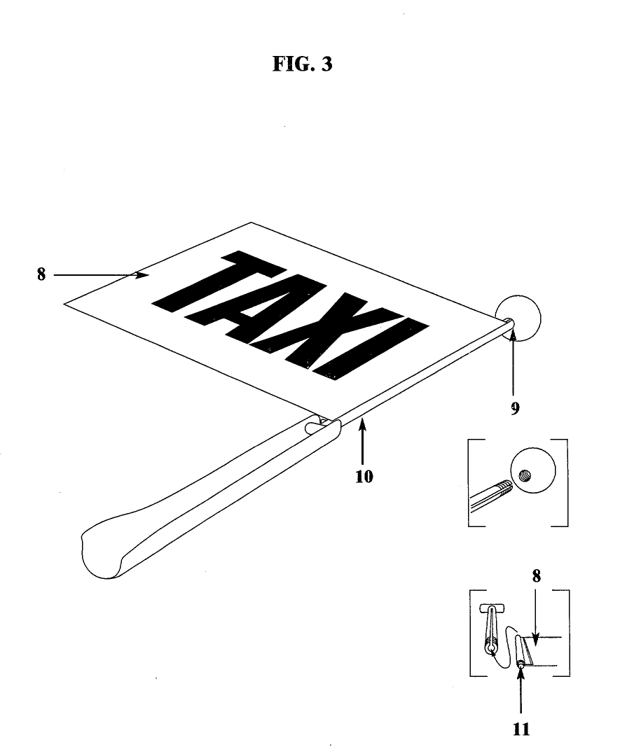

As shown in FIG. 2: the connecting end 5 of the flagholder allows the flagholder to be rotated out of the handle. It is the short end of a “T” configuration that extends equally from its center perpendicular from this end of the flagholder. It is molded plastic as a solid part of the flagholder FIG. 3 and is held in place by friction with both of its concave ends 6, shown in brackets, fitting on corresponding knobs protruding inwardly that are molded on the inside of the handle, shown in brackets, and resting in a notch in the backplate 7.

As shown in FIG. 3: The flag 8 is unfurled from the flagholder 10. The flagholder, described in part in FIG. 2, is shown here with the end of the longer extension fitting into the ball cap 9. The end of the longer portion of the flagholder is threaded so that the ball, drilled with a corresponding hole, shown in brackets, and inwardly threaded to accept the end of the flagholder by manually screwing the ball to the flagholder. The flagholder is molded with a slot, exposed at the threaded end and extending nearly to the short end of the “T” to allow the flag to be inserted at the threaded end and slid down the length of the flagholder and finally secured by the ball cap. The flag, having a string 11, sewn into one seam, shown in brackets, allows it to be inserted into a corresponding hole, larger in circumference than the width of the slot, and extending the same distance as the slot.

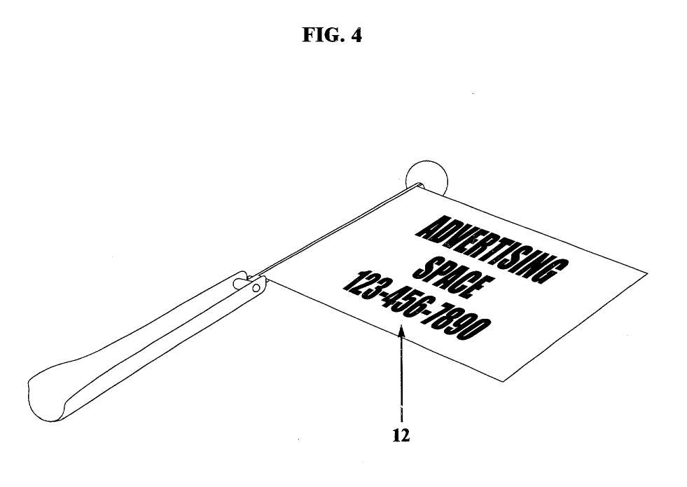

As shown in FIG. 4: the flag portion of the invention is extended showing the side that is available for the application of an advertising message 12. The application of the advertising message to the flag material is be applied via silkscreen or other suitable method, such as a computerized die transfer printed to the flag, that is impervious to moisture. The flag is made of nylon and would be available in a variety of colors.

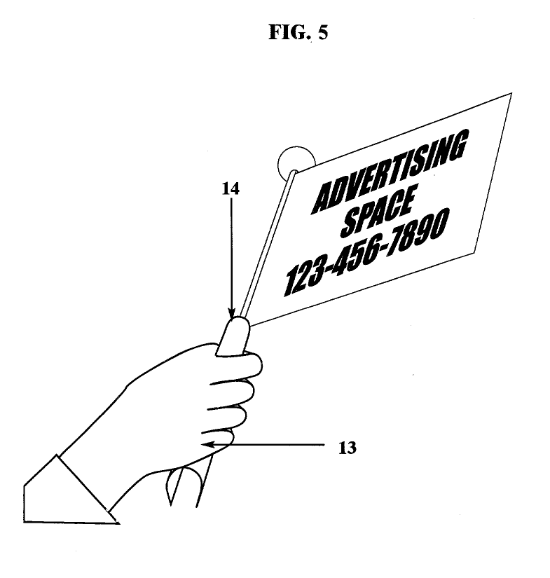

As shown in FIG. 5: the device is illustrated in use 13 with the advertising message exposed to view. As the handle is gripped firmly by the user, the pressure of firmly holding the handle prevents the flagholder from rotating beyond its open position in the forward direction and in the reverse direction by the extension of the handle 14, shown also in FIG. 1, beyond the “T” portion of the flagholder.

What I claim as my invention is:

1. a hand held taxi signaling device and advertising medium that when contracted fits into a pocket, purse or briefcase comprising:
(a) a storage compartment with a longitudinal opening, being the handle, having a flared end and a narrow end; attached at the narrow end to
(b) the short perpendicular portion of a T shaped rod that permits the rod, being the flagholder, to swivel out of the handle to its open position; to expose
(c) a nylon flag having two (2) sides that, when unrolled; has
(1) the word TAXI printed on one side; and
(2) an advertisement or logo printed on the opposite side;
(d) affixed to and rolled around the long perpendicular portion of the T shaped rod; and
(e) a screw-on ball cap at the end of the rod that when the device is contracted to its closed position secures the rod into the storage compartment at the flared end.
